(19) United States
(12) Patent Application Publication
(10) Pub. No.: US 2023/0239667 A1
(43) Pub. Date: Jul. 27, 2023

(54) METHOD AND APPARATUS FOR SUPPORTING EMERGENCY SERVICE AND PRIORITY SERVICE IN WIRELESS COMMUNICATION SYSTEM

(71) Applicant: Samsung Electronics Co., Ltd., Suwon-si (KR)

(72) Inventors: Dongeun SUH, Suwon-si (KR); Hoyeon LEE, Suwon-si (KR)

(21) Appl. No.: 18/159,603

(22) Filed: Jan. 25, 2023

(30) Foreign Application Priority Data
Jan. 26, 2022 (KR) 10-2022-0011804
Feb. 14, 2022 (KR) 10-2022-0019149

(51) Int. Cl. H04W 4/50; H04W 4/90; H04W 60/00; H04W 12/06

(52) U.S. Cl. CPC H04W 4/50; H04W 4/90; H04W 60/00; H04W 12/06

(57) ABSTRACT

The disclosure relates to a 5G or 6G communication system for supporting a higher data transmission rate. The present disclosure may be applied to intelligent services (e.g., smart home, smart building, smart city, smart car or coupled car, health care, digital education, retail, security and safety related services, etc.), based on 5G communication technologies and IoT-related technologies. A way for efficiently supporting an emergency service and a priority service in a wireless communication system of an embodiment of the present disclosure is presented.

### CROSS-REFERENCE TO RELATED APPLICATIONS

This application is based on and claims priority under 35 U.S.C. § 119 to Korean Patent Application No. 10-2022-0011804, filed on Jan. 26, 2022, and Korean Patent Application No. 10-2022-0019149, filed on Feb. 14, 2022, in the Korean Intellectual Property Office, the disclosures of which are incorporated by reference herein in their entirety.

### BACKGROUND

### 1. Field

The present disclosure relates to a method and apparatus for supporting an emergency service and a priority service in a wireless communication system.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadBand (eMBB), ultra reliable low latency communications (URLLC), and massive machine-type communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE Power Saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

An embodiment of the present disclosure presents a method and apparatus for supporting an emergency service and a priority service in a wireless communication system.

According to an embodiment of the disclosure, a method of an access and mobility management function (AMF) entity in a wireless communication system may include: receiving, from a unified data management (UDM) entity, an update notification message including first information on multimedia priority service (MPS) priority; transmitting, to a user equipment (UE), a configuration update command message including second information on the MPS priority based on the first information; and receiving, from the UE, a registration request message based on the second information.

The update notification message may be received from the UDM entity without request of the AMF entity.

The UE may determine whether access identity 1 is valid based on the second information.

The registration request message may include a parameter of establishment cause indicating priority service.

The method may further include: transmitting, to the UE, a registration accept message without authentication in at least one of a network slice admission control (NSAC) procedure or a network slice-specific authentication and authorization (NSSAA) procedure.

According to an embodiment of the disclosure, a method of a user equipment (UE) in a wireless communication system includes: receiving, from an access and mobility management function (AMF) entity, a configuration update command message including second information on the multimedia priority service (MPS) priority based on first information on MPS; and transmitting, to the UE, a registration request message based on the second information, wherein the first information is included in an update notification message transmitted from a unified data management (UDM) entity to the AMF entity.

The method may further include: determining whether access identity 1 is valid based on the second information.

The registration request message may include a parameter of establishment cause indicating priority service.

The method may further include: receiving, from the AMF entity, a registration accept message without authentication in at least one of a network slice admission control (NSAC) procedure or a network slice-specific authentication and authorization (NSSAA) procedure.

According to an embodiment of the disclosure, an access and mobility management function (AMF) entity in a wireless communication system includes: a transceiver; and a controller configured to: receive, from a unified data management (UDM) entity, an update notification message including first information on multimedia priority service (MPS) priority, transmit, to a user equipment (UE), a configuration update command message including second information on the MPS priority based on the first information, and receive, from the UE, a registration request message based on the second information.

The update notification message may be received from the UDM entity without request of the AMF entity.

The UE may determine whether access identity 1 is valid based on the second information.

The registration request message may include a parameter of establishment cause indicating priority service.

The controller may further configure to: transmit, to the UE, a registration accept message without authentication in at least one of a network slice admission control (NSAC) procedure or a network slice-specific authentication and authorization (NSSAA) procedure.

According to an embodiment of the disclosure, a user equipment (UE) in a wireless communication system includes: a transceiver; and a controller configured to: receive, from an access and mobility management function (AMF) entity, a configuration update command message including second information on the multimedia priority service (MPS) priority based on first information on MPS, and transmit, to the UE, a registration request message based on the second information, wherein the first information is included in an update notification message transmitted from a unified data management (UDM) entity to the AMF entity.

The controller may further configure to: determine whether access identity 1 is valid based on the second information.

The registration request message may include a parameter of establishment cause indicating priority service.

The controller may further configure to: receive, from the AMF entity, a registration accept message without authentication in at least one of a network slice admission control (NSAC) procedure or a network slice-specific authentication and authorization (NSSAA) procedure.

According to an embodiment of the present disclosure, a method and apparatus for supporting an emergency service and a priority service in a wireless communication system may be presented.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network structure (or network architecture) and interface of a 5G system according to an embodiment of the present disclosure;

FIG. 2 illustrates a terminal registration procedure for emergency service according to an embodiment of the present disclosure;

FIG. 3 illustrates a method of, when MPS subscription information or MCX subscription information is changed, informing an AMF and a UE of this in a terminal registration procedure according to an embodiment of the present disclosure;

FIG. 4 illustrates a method of, when MPS subscription information or MCX subscription information is changed, informing an AMF and a UE of this in a UE configuration update procedure according to an embodiment of the present disclosure;

FIG. 5 illustrates a method for exempting NSSAA in a network registration procedure of a terminal that uses an MPS or an MCX according to an embodiment of the present disclosure;

FIG. 6 illustrates a method in which an SMF or a PCF informs an AMF and a UE of MPS invocation or non-invocation in an MPS invocation procedure according to an embodiment of the present disclosure;

FIG. 7 illustrates a structure of a terminal according to an embodiment of the present disclosure;

FIG. 8 illustrates a structure of a base station according to an embodiment of the present disclosure;

FIG. 9 illustrates a structure of a network entity according to an embodiment of the present disclosure; and

FIG. 10 illustrates a method of finding out whether a new AMF has subscribed to an MPS, MCX, or MPS/MCX in a network registration procedure of a terminal according to an embodiment of the present disclosure.

### DETAILED DESCRIPTION

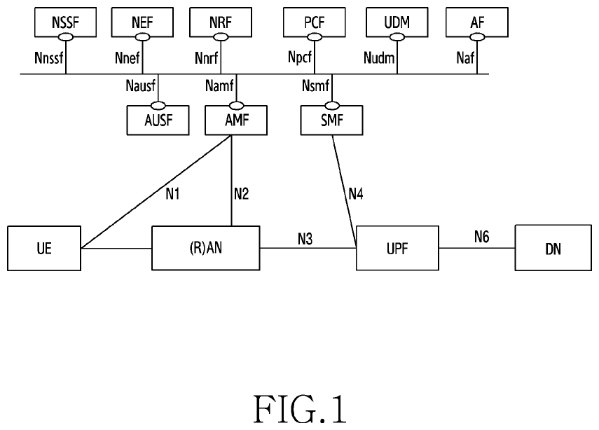

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the present disclosure will be described in detail with reference to the accompanying drawings. In describing the embodiments, a description of technical contents that are well known in the technical field to which the present disclosure pertains and are not directly related to the present disclosure will be omitted. This is to more clearly deliver the gist of the present disclosure without obscuring it by omitting unnecessary description.

For the same reason, in the accompanying drawings, some components are exaggerated, omitted, or schematically illustrated. Also, the size of each component does not entirely reflect the actual size. In each figure, the same reference number is given to the same or corresponding component.

An advantage and feature of the present disclosure, and methods of achieving them, will become clear with reference to embodiments described below in detail in conjunction with the accompanying drawings. However, the present disclosure is not limited to the embodiments disclosed below and may be implemented in various different forms, and only the present embodiments are presented to make the disclosure of the present disclosure complete, and completely inform the scope of the present disclosure to a person having a common knowledge in the technical field to which the present disclosure pertains, and the present disclosure is only defined by the scope of the claims. The same reference numbers designate the same components throughout the specification.

At this time, it will be understood that each block of the process flowchart diagrams and combinations of the flowchart diagrams may be performed by computer program instructions. These computer program instructions may be mounted in a processor of a general purpose computer, a special purpose computer, or other programmable data processing equipment, so the instructions executed by the processor of the computer or other programmable data processing equipment obtain a means performing functions described in the flowchart block(s). These computer program instructions may also be stored in a computer usable or computer readable memory that may be directed to the computer or other programmable data processing equipment so as to implement a function in a particular way, so the instructions stored in the computer usable or computer readable memory are also possible to produce an article of manufacture containing an instruction means that perform the function described in the flowchart block(s). The computer program instructions are also possible to be mounted on the computer or other programmable data processing equipment, so a series of operation steps are performed on the computer or other programmable data processing equipment to obtain a computer-executed process, and thus the instructions for performing the computer or other programmable data processing equipment are also possible to provide steps for executing the functions described in the flowchart block(s).

Also, each block may represent a portion of a module, segment, or code that includes one or more executable instructions for executing specified logical function(s). It should also be noted that, in some alternative implementations, it is possible for the functions mentioned in the blocks to occur out of order. For example, two blocks shown in succession may in fact be executed substantially concurrently, or the blocks may sometimes be executed in reverse order according to their functions.

At this time, the term “˜unit” used in the present embodiment means software or hardware components such as a field programmable gate array (FPGA) or an application specific integrated circuit (ASIC), and the “˜unit” performs certain roles. However, the “˜ unit” is not limited to software or hardware. The “˜unit” may be configured to be in an addressable storage medium and may be configured to reproduce one or more processors. Therefore, as an example, the “˜unit” includes components such as software components, object-oriented software components, class components, and task components, processes, functions, properties, procedures, subroutines, segments of a program code, drivers, firmware, microcode, circuitry, data, databases, data structures, tables, arrays, and variables. Functions presented within components and “˜units” may be combined into smaller numbers of components and the “˜units,” or be further separated into additional components and the “˜units.” In addition, the components and the “˜units” may be implemented to play one or more CPUs in a device or a secure multimedia card as well. Also, in the embodiment, the “˜ unit” may include one or more processors.

In describing the embodiments of the present disclosure, main targets are new radio (NR) that is a radio access network on the 5G mobile communication standard specified by the 3rd generation partnership project (3GPP) that is the mobile communication standardization organization, and a packet core 5G system that is a core network, or a 5G core network, or a next generation core (NG core), but the main gist of the present disclosure may be applied with slight modifications to other communication systems having similar technical backgrounds, without significantly departing from the scope of the present disclosure, and this will be possible with the judgment of a person skilled in the technical field of the present disclosure.

For convenience of description below, some terms and names defined in the 3GPP standards (5G, NR, LTE, or similar system standards) may be used. However, the present disclosure is not limited to the terms and names, and may be equally applied to systems conforming to other standards.

Also, a term for identifying a coupling node used in the following description, a term referring to network entities, a term referring to messages, a term referring to an interface between the network entities, a term referring to various identification information, and the like are illustrated for convenience of description. Therefore, the present disclosure is not limited to the terms used in the present disclosure, and other terms that refer to objects having equivalent technical meanings may be used.

In the 5G system, when a terminal registers to a network, the terminal transmits identifier information on network slices that the terminal intends to request, i.e., requested single-network slice selection assistance information (requested S-NSSAIs), to an access and mobility management function (AMF). The AMF presents information (allowed NSSAI) on the network slices that may be used by the terminal, to the terminal, in consideration of the requested S-NSSAIs, subscriber information, and the like. Even if the terminal does not present the above-described identifier information on the slices to be requested, the AMF may present the allowed NSSAI to the terminal. At this time, the allowed NSSAI may include information (default configured NSSAIs) on default configured slices, and information (i.e., default subscribed S-NSSAIs) on default configured slices among subscription slices included in terminal subscriber information.

When no slices may be included in the allowed NSSAI (for example, when the default configured NSSAI and the default subscribed S-NSSAIs do not exist or are unavailable), the AMF transmits a network registration rejection message to the terminal, along with a cause code indicating a reject registration cause that there is no available slice.

Meanwhile, when a certain slice is to be included in the allowed NSSAI of the terminal, a network slice admission control (NSAC) procedure and a network slice-specific authentication and authorization (NSSAA) procedure for the corresponding slice may be performed. The NSAC procedure determines whether to allow the corresponding slice, based on the number of terminals currently registered to a specific slice and the maximum number of registered terminals allowed for the corresponding slice (i.e., determines whether the corresponding slice is included in the allowed NSSAI). In the NSSAA procedure, an authentication procedure is performed with an AAA-S which is a server that performs authentication for a corresponding slice through a NSSAA function (NSSAAF), based on credential information of the terminal for the corresponding slice. In the case of a slice requiring the NSAC and NSSAA procedures, only when both procedures succeed, the corresponding slice may be included in the allowed NSSAI.

Emergency services refer to specific services presented to a terminal in an emergency situation, for example, emergency call services, etc. When registering to a network, the terminal may include a parameter indicating registration for emergency service in a registration request message. The terminal performing the registration for the emergency service does not include information on a desired network slice in the registration request message. The AMF supporting emergency service stores a slice and a data network name (i.e., a data network name (DNN)) for emergency service as configuration information. When the emergency service is presented to the terminal, the AMF presents emergency service to the terminal through the corresponding slice and DNN. At this time, the corresponding slice is not included in the allowed NSSAI transmitted to the terminal. Also, the terminal registered for emergency service cannot use slices other than the slice for emergency service.

Even though the slices other than the slice for emergency service do not need to be allowed, when no slice is included in the allowed NSSAI, the terminal performing the registration for emergency service may determine that the AMF rejects the registration.

An embodiment of the present disclosure is to prevent such a situation, and presents a method and apparatus for, even if the AMF does not include any slice in the allowed NSSAI for the terminal performing the registration for emergency service, preventing a registration rejection from occurring due to this.

When a slice unrelated to emergency service is included in the allowed NSSAI for the terminal that has requested the registration for emergency service, the terminal may determine that the corresponding slice may be used, and request a session through the corresponding slice. However, a session through other slices and/or DNNs other than an emergency slice and an emergency DNN is not allowed to the terminal registered for emergency service. Accordingly, when the slice unrelated to emergency service is included in the allowed NSSAI, an unnecessary terminal session request may occur. Also, the terminal performing the registration for emergency service may perform the NSAC or NSSAA procedures for including some slices (e.g., default configured NSSAI or default subscribed NSSAIs) in the allowed NSSAI, even though other slices other than the slice for emergency service need not be allowed. This operation causes an unnecessary signaling load of a control plane.

An embodiment of the present disclosure is to prevent such a situation, and presents a method and apparatus for reducing unnecessary signaling in the case of a terminal performing a registration for emergency service.

On the other hand, a multimedia priority service (MPS) is a service that allows a user (for example, a government official, etc.) defined as a service user to preferentially access a mobile communication system resource. Also, an MCX (i.e., a mission critical service) is a service that allows a user, etc. belonging to a mission critical organization to preferentially access a system resource for a mission critical application (e.g., mission critical push to talk (MCPTT), mission critical video (MCVideo), mission critical data (MCData), etc.).

When the terminal needs an access to the 5G system, the terminal performs an assess barring check on whether the access is allowed. When a network access stratum (NAS) layer of the terminal detects an access request from an upper layer, the NAS layer classifies the corresponding access into one or more access identities and one access category. At this time, the NAS layer determines an access identity and an access category with reference to a UE profile including a reason for access, types of service requested, and user equipment (UE) configuration information. Then, the NAS layer delivers the determined access identity and access category to a lower protocol layer. The lower protocol layer of the terminal performs the access barring check, based on the received access identity and access category.

The terminal determines whether an access identity value corresponding to each MPS or MCX is valid for the terminal, based on UE profile information (access identity information usable in a home network exists in a USIM) or MPS-related subscriber information or MCX-related subscriber information received from the AMF. Specifically, when the terminal is roaming, or when the terminal is not roaming, when the access identity information corresponding to the MPS or MCX in the home network is not set to the USIM, the terminal determines whether the access identity value corresponding to each MPS or MCX is valid for the terminal, based on the MPS-related subscriber information or MCX-related subscriber information received from the AMF.

When the terminal performs a network access corresponding to the MPS or MCX in a network registration procedure, the terminal sets an establishment cause for a radio resource control (RRC) layer included in a message transmitted to a base station (radio access network (RAN) node), as a value indicating a priority service (MPS or MCX). When the establishment cause value is the value indicating the priority service, the base station transmits a message including the establishment cause to the AMF. When the establishment cause indicates the priority service (that is, when the establishment cause includes the value indicating the priority service or an information element (IE)), the AMF performs preferential processing in consideration of this. Only when the access identity value corresponding to the MPS or MCX is set, the terminal may include the value indicating the priority service or the IE in the establishment cause.

At this time, in a situation where a general terminal not using the MPS or MCX is roaming, or the access identity information corresponding to the MPS or MCX is not set to terminal configuration information (e.g., a USIM), the MPS-related subscriber information or MCX-related subscriber information may be added to subscriber information on a corresponding terminal of user data management (UDM). Since the corresponding terminal does not know whether the subscriber information has been updated prior to network registration, when registering to the network for the first time after changing the MPS-related subscriber information and MCX-related subscriber information, the value indicating the priority service or the IE may not be included in the establishment cause. Since the AMF does not know that it is a terminal that uses the MPS or MCX, the AMF does not perform preferential processing of a registration request message, etc. of the terminal (i.e., preferential processing of a message from the corresponding terminal when the establishment cause indicates the MPS or MCX). Also, when the AMF receives the establishment cause indicating the MPS or MCX, the AMF processes request slices as an exception to an NSAC procedure, but when the AMF does not receive the establishment cause for the MPS or MCX, since the request slices cannot be processed as the exception to the NSAC procedure, some slices may be rejected, or a registration request itself may be rejected. Therefore, when the MPS-related subscriber information or MCX-related subscriber information is changed, a method for informing a UE of this is required.

In the 5G system, even for a general terminal not having the MPS-related subscriber information, the AMF may request a policy control function (PCF) to use an MPS service. However, even in this case, it is necessary to inform a corresponding terminal that the access identity corresponding to the MPS is valid and the corresponding access identity should be used. Otherwise, when the corresponding terminal performs re-registration due to mobility or the like, a registration rejection situation as mentioned above may occur. Therefore, when the MPS service is activated, a method for informing the UE of this is required.

On the other hand, in the 5G system, when the MPS-related subscriber information or MCX-related subscriber information exists (i.e., when the corresponding terminal has subscribed to the MPS and MCX), the AMF may perform preferential processing of messages received from the terminal (e.g., including of a header for preferential processing in a communication message between network functions of a control plane, NSSAA exemption, NSAC exemption, etc.). This is called subscriber information-based priority service provision.

Finally, there may be cases in which a registration for an MPS or MCX is rejected due to an NSSAA procedure. Therefore, a parameter of informing the registration for the MPS or MCX is transmitted to a 3rd party server (authentication, authorization, and accounting server (AAA-S)) or NSSAAF which performs the NSSAA procedure such that, when there is a slice authentication request in a registration procedure for the MPS or MCX, the AAA-S or NSSAAF may be prevented from rejecting authentication even though there is no credential.

In an embodiment of the present disclosure, a method and apparatus for, in the case of a registration for emergency service, preventing the AMF from rejecting the registration even when no slice is included in the allowed NSSAI are presented.

Also, in an embodiment of the present disclosure, a method and apparatus for, in the case of registration for emergency service, not proceeding with a slice-related procedure for slices unrelated to emergency service, and not presenting slice information unrelated to emergency service to a terminal are presented. Specifically, in a registration accept message delivered to the terminal, 1) allowed NSSAI is not presented, 2) allowed NSSAI includes identifier information of a slice used for emergency service, or 3) allowed NSSAI includes predefined slice identifier information signifying an emergency registration agreed with the terminal.

Also, in an embodiment of the present disclosure, a method and apparatus of, when the MPS-related subscriber information or MCX-related subscriber information is changed, being capable of informing a UE of this are presented. Furthermore, in the case of a terminal using the MPS and/or MCX in a registration procedure, a method and apparatus for exempting NSSAA are presented.

According to an embodiment of the present disclosure, a situation may be prevented in which a terminal registering for emergency service in a wireless communication system is registration rejected due to a situation in which there is no allowed slice, and unnecessary network signaling may be prevented from occurring.

Also, according to an embodiment of the present disclosure, when the MPS-related subscriber information or MCX-related subscriber information is changed in the wireless communication system, by informing the terminal and the AMF of this, it is possible to perform an appropriate operation. Furthermore, the NSSAA may be exempted in the case of the terminal using the MPS and/or MCX in the registration procedure of the wireless communication system.

FIG. 1 illustrates a network structure (or network architecture) and interface of a 5G system according to an embodiment of the present disclosure.

Referring to FIG. 1, the network structure of the 5G system may include user equipment (UE), a radio access network ((R)AN), an access and mobility management function (AMF), a session management function (SMF), a user plane function (UPF), a data network (DN), a network slice selection function (NSSF), a network exposure function (NEF), an authentication server function (AUSF), a network repository function (NRF), a policy control function (PCF), unified data management (UDM), an application function (AF), etc.

Here, the UE may mean a terminal. The 5G-RAN means a base station that presents a wireless communication function to the terminal. In FIG. 1, the 5G-RAN is shown as the (R) AN. The AMF manages the mobility of the terminal. The SMF manages a packet data network coupling presented to the terminal. This coupling is called a protocol data unit (PDU) session. The UPF plays a role of a gateway delivering packets transmitted and received by the terminal. The UPF may be coupled to the data network (DN) and play a role of delivering data packets provided by the 5G system to an external data network, and may, for example, be coupled to the data network coupled by the internet, and route data packets transmitted by the terminal, to the Internet.

The NSSF performs a function of selecting a network slice instance presented to the terminal. The NEF may access information that manages the terminal in the 5G network and thus, is coupled to 5G core network network functions (NFs), and plays a role of delivering information on the terminal to the corresponding NFs or reporting the information on the terminal to the outside, such as a subscription to a mobility management event of the corresponding terminal, a subscription to a session management event of the corresponding terminal, a request for session-related information, setting of charging information of the corresponding terminal, a PDU session policy change request for the terminal, etc. The AUSF performs terminal authentication in 3GPP access networks and non-3GPP access networks. The NRF performs the function of discovering the NF. The PCF applies a mobile communication service provider's service policy, a billing policy, and a PDU session policy on the terminal. The UDM stores and manages data such as subscriber data, policy control data, etc. The AF may use services and functions presented by the 5G network through the NEF.

Furthermore, although not shown in FIG. 1, the network of the 5G system may further include other network functions (NFs). For example, it may further include a unified data repository (UDR) that stores various function data such as PCF data, UDM data, and NEF data.

In a 3GPP system, a conceptual link coupling NFs in the 5G system is defined as a reference point. The following are reference points included in a 5G system architecture:
N1: Reference point between UE and AMF;
N2: Reference point between (R)AN and AMF;
N3: Reference point between (R)AN and UPF;
N4: Reference point between SMF and UPF;
N5: Reference point between PCF and AF;
N6: Reference point between UPF and DN;
N7: Reference point between SMF and PCF;
N8: Reference point between UDM and AMF;
N9: Reference point between two core UPFs;
N10: Reference point between UDM and SMF;
N11: Reference point between AMF and SMF;
N12: Reference point between AMF and AUSF;
N13: Reference point between UDM and AUSF;
N14: Reference point between two AMFs; and
N15: Reference point between PCF and AMF in case of a non-roaming scenario, and/or reference point between PCF and AMF in a visited network in case of a roaming scenario.

Meanwhile, network slicing in the 5G system is a technology that enables a plurality of virtualized and independent logical networks in one physical network. A network operator may present services by configuring a virtual end-to-end network called a network slice in order to satisfy specific requirements of services and/or applications. At this time, the network slice is distinguished by an identifier that is called single-network slice selection assistance information (S-NSSAI). The network may transmit a set of slices (e.g., allowed NSSAI(s)) allowed to the terminal in a terminal registration procedure (e.g., a UE registration procedure), and the terminal may transmit and receive application data through a protocol data unit (PDU) session provided through one S-NSSAI (i.e., network slice) among them.

An embodiment of the present disclosure presents a method and apparatus for preventing the AMF from rejecting registration even if no slice is included in the allowed NSSAI in case of registration for emergency service.

Also, an embodiment of the present disclosure presents a method and apparatus in which, in case of registration for emergency service, a slice-related procedure for slices unrelated to emergency service does not proceed, and slice information unrelated to emergency service is not presented to a terminal. Specifically, in a registration accept message delivered to the terminal, 1) allowed NSSAI is not presented, 2) allowed NSSAI includes identifier information of a slice used for emergency service, or 3) allowed NSSAI may include predefined slice identifier information indicating that it is emergency registration agreed with the terminal.

Also, an embodiment of the present disclosure presents a method and apparatus capable of, when MPS-related subscriber information or MCX-related subscriber information is changed, informing the UE of this. Furthermore, an embodiment of the present disclosure presents a method and apparatus for exempting NSSAA in case of a terminal using MPS and/or MCX in a registration procedure.

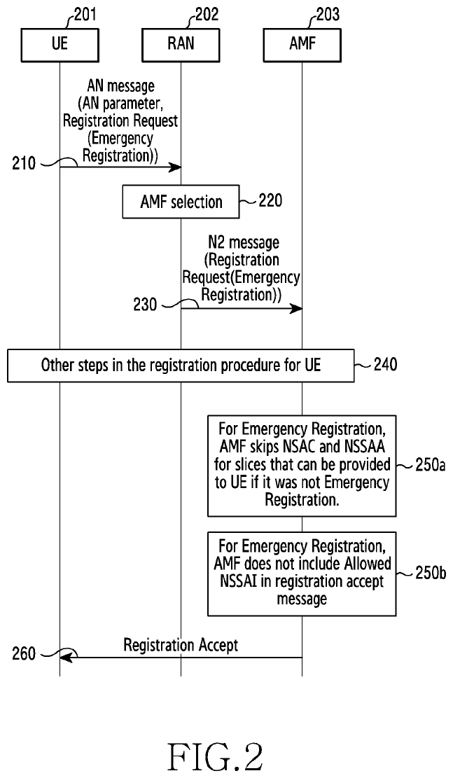

FIG. 2 illustrates a terminal registration procedure for emergency service according to an embodiment of the present disclosure.

In step 210, a UE 201 may transmit an AN message including an AN parameter and a registration request to an RAN 202. At this time, the registration request may include a UE identifier (e.g., a subscription concealed identifier (SUCI), a 5G-globally unique temporary identity (5G-GUTI), a permanent equipment identifier (PEI), etc.), a requested NSSAI, a UE mobility management (MM) core network capability, etc.

When the UE 201 performs registration for emergency services, the UE 201 may include a value indicating emergency registration in the registration request in a request type.

In step 220, the RAN 202 may select an AMF 203, based on information within the AN message received from the UE 201. When the UE 201 requests registration for emergency services, that is, when the value indicating the emergency registration is included in the request type of the registration request message, the RAN 202 may select the AMF 203, based on setting information on emergency services.

In step 230, the RAN 202 may deliver the N2 message including the N2 parameter and the registration request to the AMF 203. The N2 parameter may include a selected PLMN ID, UE location information, a UE context request, and the like.

Also, the N2 message may include a RAN ID.

In step 240, steps necessary for the UE registration procedure may be performed.

In step 250a, when the request type in the registration request is the value indicating the emergency registration, the AMF 203 skips an NSAC procedure and an NSSAA procedure. Furthermore, in the case of a general registration request rather than emergency registration, even when there are slices available for the UE 201, the AMF 203 skips the NSAC procedure and the NSSAA procedure for the corresponding slices.

In step 250b, when the request type in the registration request is the value indicating the emergency registration, the AMF 203 does not include slice information (allowed NSSAI) available for the terminal in a registration accept message presented to the UE 201. Furthermore, when the AMF 203 supports emergency service and has no reason to reject the registration request for emergency service of the UE 201 for other reasons, the registration accept message presented to the UE 201 may include an indicator indicating a registration accept for emergency service. At this time, the registration accept message does not include slice information (allowed NSSAI) available for the UE 201, and/or the allowed NSSAI may include slice information for emergency service, a predefined slice identifier value indicating a registration for emergency service, etc.

In step 260, the AMF 203 constructs a registration accept message, based on the decision on the allowed NSSAI in step 250b, and transmits the registration accept message to the UE 201.

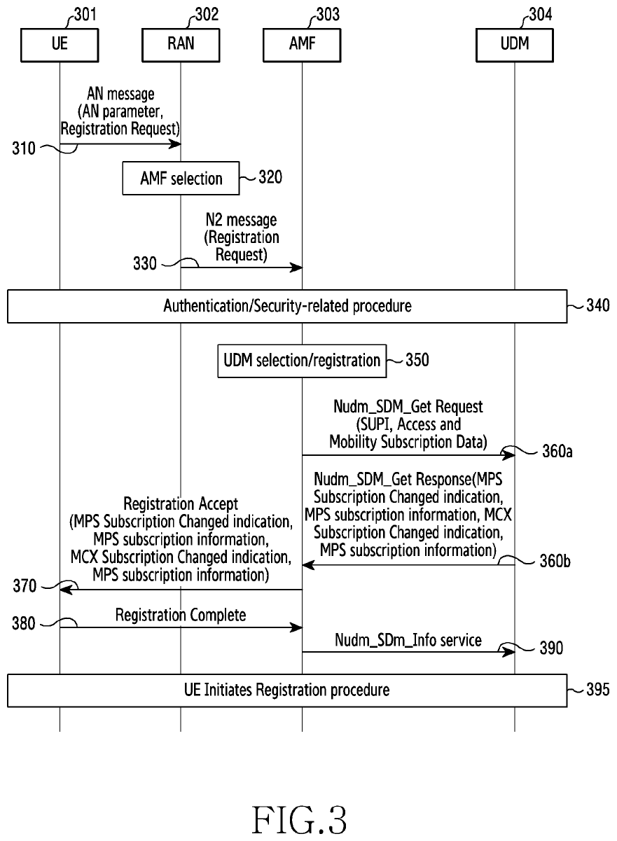

FIG. 3 illustrates a method of, when MPS subscription information or MCX subscription information is changed, informing an AMF and a UE of this in a terminal registration procedure according to an embodiment of the present disclosure.

In step 310, the UE 301 may transmit an AN message including an AN parameter and a registration request to an RAN 302. At this time, the registration request may include a UE identifier (e.g., a subscription concealed identifier (SUCI), a 5G-globally unique temporary identity (5G-GUTI), a permanent equipment identifier (PEI), etc.), a requested NSSAI, a UE mobility management (MM) core network capability, etc.

In step 320, the RAN 302 may select the AMF 303, based on information in the AN message received from the UE 301.

In step 330, the RAN 302 may deliver the N2 message including the N2 parameter and registration request to the AMF 303. The N2 parameter may include a selected PLMN ID, UE location information, a UE context request, and the like.

In step 340, when the AMF 303 determines that UE authentication is required, the AMF 303 may select an authentication server function (AUSF), based on the UE identifier (e.g., the SUCI or SUPI), and perform an authentication procedure for the UE 301 through the selected AUSF. Also, when there is no security context for NAS communication for the UE 301, a procedure for acquiring this may be performed.

In step 350, the AMF 303 may select a UDM 304, based on the SUPI (i.e., the UE identifier). Also, the UDM 304 may select a UDR in which subscription information for the UE 301 is stored. The AMF 303 may request the UDM 304 to register for an access type (e.g., 3GPP access or non-3GPP access) for which a registration request for the UE 301 was received.

In step 360a, the AMF 303 may transmit a Nudm_SDM_Get request message including an indicator requesting for UE identifier information and access and mobility subscription data information to the UDM 304, to request access and mobility subscription information to the UDM 304.

In step 360b, the UDM 304 includes access and mobility subscription data in a Nudm_SDM_Get response message and transmits the Nudm_SDM_Get response message to the AMF 303. At this time, the UDM 304 may acquire the access and mobility subscription data from the UDR.

When a change occurs in the MPS subscription information (i.e., an MPS priority) stored in the UDM 304 or the UDR (for example, when the MPS subscription information was not existing but is newly added to subscriber information), the UDM 304 or UDR may set an MPS subscription changed indication value of the internally stored access and mobility subscription data, as a value indicating that a change has occurred, and may include an MPS subscription changed indication indicating that the change has occurred, the MPS subscription information, etc. in data transmitted to the AMF 303.

When a change occurs in the MCX subscription information (i.e., an MCX priority) stored in the UDM 304 or the UDR (for example, when the MCX subscription information was not existing but is newly added to the subscriber information), the UDM 304 or the UDR may set an MPS subscription changed indication value of the internally stored access and mobility subscription data, as a value indicating that a change has occurred, and may include an MCX subscription changed indication indicating that the change has occurred, the MCX subscription information, etc. in data transmitted to the AMF 303.

When the MPS subscription changed indication is included in the Nudm_SDM_Get response message received in step 360b, the AMF 303 may operate as follows in step 370.

When a value indicating whether the use of access identity 1 of the UE 301 within a public land mobile network (PLMN) is valid changes from a value indicating validity to a value indicating invalidity in the MPS subscription information, the AMF 303 may no longer include header information for a priority service in communication with other network functions (NFs).

When the MCX subscription changed indication is included in the message received in step 360b, the AMF 303 may operate as follows in step 370.

When a value indicating whether the use of access identity 2 of the UE 301 within the PLMN is valid changes from a value indicating validity to a value indicating invalidity in the MCX subscription information, the AMF 303 may no longer include the header information for the priority service in the communication with other network functions (NFs).

When the message received in step 360b includes the MCX subscription changed indication, in step 370, upon determining an allowable slice for the UE 301, the AMF 303 may exempt NSAC or NSSAA, or send a registration accept message to the UE 301 even though there is no allowable slice. When the message received in step 360b includes the MPS subscription changed indication, in step 370, the AMF 303 may inform the UE 301 of the changed information, and in order for the UE 301 to operate accordingly to this, the AMF 303 may transmit information such as the MPS subscription changed indication, the MPS subscription information, etc.

When the message received in step 360b includes the MCX subscription changed indication, in step 370, the AMF 303 may inform the UE 301 of the changed information, and in order for the UE 301 to operate accordingly to this, the AMF 303 may transmit information such as the MCX subscription changed indication, the MPS subscription information, etc.

When the message received in step 370 includes the MPS subscription changed indication or the MCX subscription changed indication, in step 380, the UE 301 may transmit a registration complete message to the AMF 303. The registration complete message may include information indicating that the changed MPS subscription information has been received in case of MPS, information indicating that the changed MCX subscription information has been received in case of MCX, and the like.

When the message received in step 380 includes the information indicating that the changed MPS subscription information has been received, in step 390, the AMF 303 transmits information (Nudm_SDm_Info) indicating that the changed information has been successfully delivered to the UE 301, to the UDM 304. Upon receiving the corresponding information, the UDM 304 changes the MPS subscription changed indication value from a value indicating that a change has occurred to a value indicating that there is no change, within the access and mobility subscription data.

When the message received in step 380 includes the information indicating that the changed MCX subscription information has been received, in step 390, the AMF 303 transmits information (Nudm_SDm_Info) indicating that the changed information has been successfully delivered to the UE 301, to the UDM 304. Upon receiving the corresponding information, the UDM 304 changes the MCX subscription changed indication value from a value indicating that a change has occurred to a value indicating that there is no change, within the access and mobility subscription data.

In step 395, when the message received in step 370 includes an MPS subscription changed indication, and a value indicating whether the use of access identity 1 of the UE 301 within the PLMN is valid is a value indicating validity in the MPS subscription information, and when it is desired to perform network registration for an MPS service, the UE 301 may perform a registration request to the network again. Or, when the message received in step 370 includes an MCX subscription changed indication, and a value indicating whether the use of access identity 2 of the UE 301 within the PLMN is valid is a value indicating validity in the MCX subscription information and when it is desired to perform the network registration for the MCX service, the UE 301 may perform a registration request to the network again.

At this time, when the UE 301 includes a parameter indicating a request for a priority service in an establishment cause of the AN parameter, and the RAN 302 includes a parameter indicating a request for a high priority service in the establishment cause, the RAN 302 transmits including the establishment cause to the AMF 303. When the establishment cause indicates the priority service, the AMF 303 may include header information requesting preferential processing in communication with other NFs.

When the establishment cause indicates the priority service, the AMF 303 may store information indicating that the UE 301 is using the priority service in a UE context.

When the establishment cause indicates the priority service, the AMF 303 does not perform NSAC and NSSAA procedures for slices, or even when the result of the NSAC or NSSAA procedure fails, the AMF 303 may ignore the result and allow the corresponding slice, or include a parameter requesting exemption to the NSACF or NSSAAF in the NSAC or NSSAA procedure, respectively, as well.

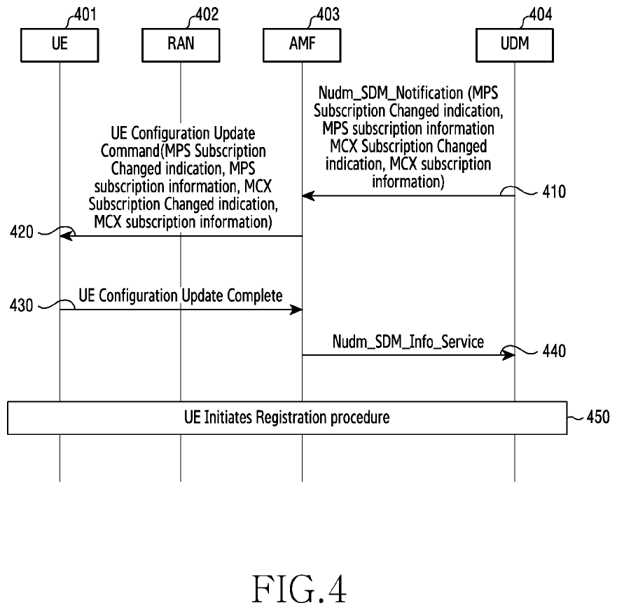

FIG. 4 illustrates a method of, when MPS subscription information or MCX subscription information is changed, informing an AMF 403 and a UE 401 of this in a UE configuration update procedure according to an embodiment of the present disclosure.

In step 410, when subscriber information is changed, a UDM 404 may inform the AMF 403 of this.

At this time, the UDM 404 may acquire access and mobility subscription data from a unified data repository (UDR).

When the MPS subscription information (i.e., an MPS priority) stored in the UDM 404 or UDR is changed (for example, when the MPS subscription information was not existing in the subscriber information but is newly added), the UDM 404 or UDR may set an MPS subscription changed indication value to internally stored access and mobility subscription data, as a value indicating that a change has occurred, and may include the MPS subscription changed indication indicating that a change has occurred, the MPS subscription information, etc. in data transmitted to the AMF 403.

When the MCX subscription information (i.e., an MCX priority) stored in the UDM 404 or UDR is changed (for example, when the MCX subscription information was not existing in the subscriber information but is newly added), the UDM 404 or UDR may set an MCX subscription changed indication value to the internally stored access and mobility subscription data, as a value indicating that a change has occurred, and may include the MCX subscription changed indication indicating that a change has occurred, the MCX subscription information, etc. in the data transmitted to the AMF 403.

When the message received in step 410 includes the MPS subscription changed indication, the AMF 403 may operate as follows in step 420.

When a value indicating whether the use of access identity 1 of the UE 401 within the PLMN is valid changes from a value indicating validity to a value indicating invalidity in the MPS subscription information, the AMF 403 may no longer include header information for a priority service in communication with other network functions (NFs).

When the message received in step 410 includes the MCX subscription changed indication, the AMF 403 may operate as follows in step 420.

When a value indicating whether the use of access identity 2 of the UE 401 within the PLMN is valid changes from a value indicating validity to a value indicating invalidity in the MCX subscription information, the AMF 403 may no longer include header information for a priority service in communication with other network functions (NFs).

When the message received in step 410 includes the MPS subscription changed indication, the AMF 403 may inform the terminal of the changed information, and in order for the terminal to operate accordingly to this, the AMF 403 may transmit information of the MPS subscription changed indication, the MPS subscription information, etc.

When the message received in step 410 includes the MCX subscription changed indication, the AMF 403 may inform the terminal of the changed information, and in order for the terminal to operate accordingly to this, the AMF 403 may transmit information of the MCX subscription changed indication, the MCX subscription information, etc.

When the message received in step 420 includes the MPS subscription changed indication or the MCX subscription changed indication, in step 430, the UE 401 may transmit a registration complete message to the AMF 403. The registration complete message may include information indicating that the changed MPS subscription information has been received in case of MPS, information indicating that the changed MCX subscription information has been received in case of MCX, etc.

When the message received in step 430 includes information indicating that the changed MPS subscription information has been received, in step 440, the AMF 403 transmits information (Nudm_SDm_Info) indicating that the changed information has been successfully delivered to the UE 401, to the UDM 404. Upon receiving the corresponding information, the UDM 404 changes the MPS subscription changed indication value from a value indicating that a change has occurred to a value indicating that there is no change in the access and mobility subscription data.

When the message received in step 430 includes information indicating that the changed MCX subscription information has been received, in step 440, the AMF 403 transmits information (Nudm_SDm_Info) indicating that the changed information has been successfully delivered to the terminal, to the UDM 404. Upon receiving the corresponding information, the UDM 404 changes the MCX subscription changed indication value from a value indicating that a change has occurred to a value indicating that there is no change in the access and mobility subscription data.

In step 450, when the message received in step 420 includes the MPS subscription changed indication, and a value indicating whether the use of access identity 1 of the UE 401 within the PLMN is valid is a value indicating validity in the MPS subscription information, and when it is desired to perform network registration for an MPS service, the UE 401 may perform a registration request to the network again. Or, when the message received in step 420 includes the MCX subscription changed indication, and a value indicating whether the use of access identity 2 of the UE 401 within the PLMN is valid is a value indicating validity in the MCX subscription information, and when it is desired to perform network registration for an MCX service, the UE 401 may perform a registration request to the network again.

At this time, when the UE 401 includes a parameter indicating a request for a priority service in an establishment cause of an AN parameter, and the establishment cause includes a parameter indicating a request for a high priority service, the RAN 402 transmits including the establishment cause to the AMF 403. When the establishment cause indicates the priority service, the AMF 403 may include header information requesting preferential processing in communication with other NFs.

When the establishment cause indicates the priority service, the AMF 403 may store information indicating that the UE 401 is using the priority service in a UE context.

When the establishment cause indicates the priority service, the AMF 403 does not perform NSAC and NSSAA procedures for slices, or even if the result of the NSAC or NSSAA procedure fails, the AMF 403 may ignore the result and allow the corresponding slice, or may include a parameter requesting an exemption to the NSACF or NSSAAF in the NSAC or NSSAA procedure, respectively, as well.

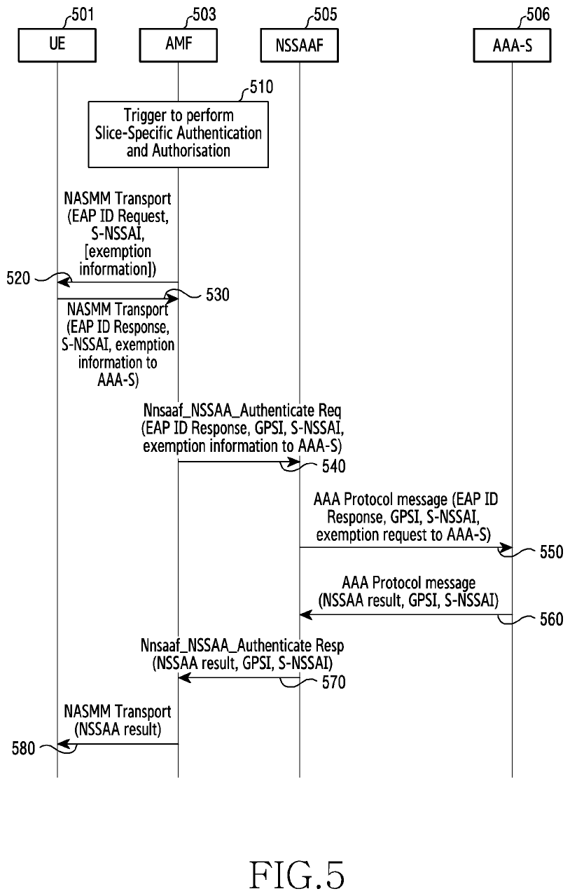

FIG. 5 illustrates a method for exempting NSSAA in a network registration procedure of a terminal that uses an MPS or MCX according to an embodiment of the present disclosure.

In step 510, the AMF 503 may perform an NSSAA procedure for network slices requiring NSSAA.

When NSSAA is performed as a result of a terminal registration procedure, the AMF 503 may determine which slices are NSSAA targets, based on stored UE information (i.e., UE context).

At this time, when information indicating that the UE 501 is using MPS or MCX is stored in the UE context of the AMF 503, or when the AMF 503 receives an establishment cause indicating a priority service in the terminal registration procedure, the AMF 503 may skip NSSAA, or perform an exemption request in the NSSAA procedure.

Steps 520 and 530 are used when the UE 501 performs the exemption request.

Step 540 is used when the AMF 503 performs the exemption request.

In step 520, the AMF 503 may transmit EAP ID Request, S-NSSAI, and [exemption information] to the UE 501.

An extensible authentication protocol (EAP) is a protocol used for authentication of S-NSSAI of the UE between the UE and the AAA-S in the NSSA procedure.

When information indicating that the UE 501 is using the MPS or MCX is stored in the UE context of the AMF 503, or the AMF 503 receives an establishment cause indicating a priority service in the terminal registration procedure in step 510, the AMF 503 may include the exemption information. The exemption information may include an indicator indicating that authentication exemption is required, information required when the terminal performs the authentication exemption request, and the like.

In step 530, the UE 501 may transmit EAP ID Response, S-NSSAI, and exemption information to AAA-S, to the AMF 503.

When the exemption information is received in step 520 or when self is using an MPS or MCX service (that is, when access identity is determined to be 1 or 2), in step 530, the UE 501 may include the exemption information to AAA-S including request information for an authentication exemption to AAA-S, in a message sent to the AMF 503.

In step 540, when the exemption information to AAA-S is received from the UE 501 in step 530, or information indicating that the UE 501 is using MPS or MCX is stored in a UE context of the AMF 503, or an establishment cause indicating a priority service is received in the terminal registration procedure, the AMF 503 may include the exemption information to AAA-S in a message sent to the NSSAAF 505. Also, the message sent to the NSSAAF 505 may include GPSI, S-NSSAI, and EAP ID Response. The EAP ID Response is not included when steps 520 and 530 are not performed.

In step 550, the NSSAAF 505 converts a message format received from the AMF 503 into an AAA protocol format and delivers the AAA protocol format to the AAA-S 506. When the AAA-S 506 is a server belonging to a third party, the corresponding message may be delivered to the AAA-S 506 through a proxy server (i.e., AAA-P) for an AAA protocol.

In step 560, the AAA-S 506 may include an NSSAA result, GPSI, and S-NSSAI in the response message to the NSSAAF 505 and transmit the response message.

When the message received from the NSSAAF 505 in step 550 includes the exemption information to AAA-S, in step 560, the AAA-S 506 may include information indicating that authentication succeeds for the terminal (GPSI) and the slice (S-NSSAI) in the NSSAA result.

When receiving the exemption information to AAA-S, the AAA-S 506 may stop an authentication procedure that is based on the EAP protocol.

In step 570, the NSSAAF 505 converts a message format received from the AAA-S 506 into a format that the NSSAAF 505 may comprehend and forwards to the AMF 503. When the AAA-S 506 is a server belonging to a third party, the corresponding message may be delivered to the NSSAAF 505 through a proxy server (i.e., AAA-P) for the AAA protocol.

In step 580, when the NSSAA result of the message received in step 570 succeeds, the AMF 503 may store S-NSSAI in the UE context. Also, the AMF 503 may transmit the NSSAA result to the UE 501.

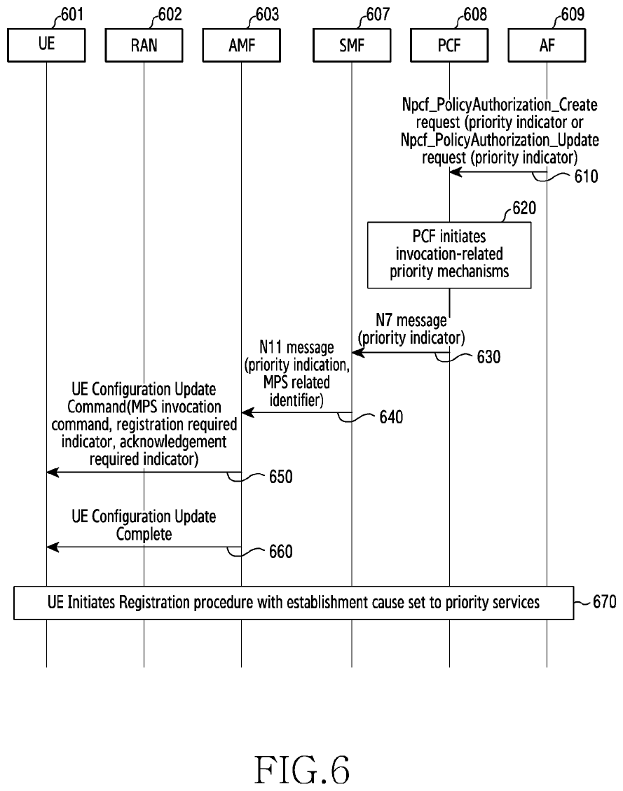

FIG. 6 illustrates a method in which an SMF or a PCF informs an AMF and a UE of MPS invocation or non-invocation in an MPS invocation procedure according to an embodiment of the present disclosure.

In step 610, an AF 609 may transmit a priority indicator to a PCF 608 for the sake of MPS invocation. Specifically, the AF 609 may transmit information such as a UE identity, a DNN, S-NSSAI, a media type, a media format, a flow description, an AF application identifier, a priority indicator, an access type, etc. to the PCF 608.

In step 620, when the priority indicator exists in a message from the AF 609 in step 610, the PCF 608 starts a procedure for invocation of an MPS service, based on parameters received from the AF 609 in step 610.

When the priority indicator exists in the message from the AF 609 in step 610, in step 630, the PCF 608 transmits the priority indicator to an SMF 607 so as to inform that the UE 601 uses the MPS service.

Also, the PCF 608 may transmit the UE Identity, the DNN, the S-NSSAI, a QoS flow description, the access type, etc. to the SMF 607.

When the priority indicator exists in the message from the PCF 608 in step 630, in step 640, the SMF 607 transmits the priority indicator in order to inform an AMF 603 that the UE 601 uses the MPS service.

Also, the SMF 607 may transmit the UE identity, the DNN, the S-NSSAI, the access type, etc. to the AMF 603.

In step 650, when the priority indicator exists in the message from the SMF 607 in step 640, and when it is determined that the UE 601 is a terminal not yet using the MPS service, the AMF 603 may transmit information such as an MPS invocation command, a registration required indicator, an acknowledgment required indicator/information, etc., to the UE 601.

The MPS invocation command is information for informing the terminal that an MPS has been invocated, and instructing the terminal to operate as a terminal that uses the MPS service.

The registration required indicator is information for requesting the terminal to re-register to a network as the terminal that uses the MPS.

The acknowledgment required indicator/information is information requesting to inform whether or not the terminal has been set as the terminal that uses the MPS.

In step 660, when the UE 601 receives the MPS invocation command in a message from the AMF 603, the UE 601 operates as the UE 601 that uses the MPS. That is, the UE 601 sets the access identity to 1, and upon performing a network registration procedure, the UE 601 sets an establishment cause as priority services to a message which is sent to the RAN 602, and sends the message.

When the message from the AMF 603 includes the acknowledgment required indicator/information, the UE 601 transmits a message for acknowledging that the UE 601 operates as the UE 601 that uses the MPS, to the AMF 603. Upon receiving the corresponding message from the terminal, the AMF 603 stores information indicating that the corresponding UE 601 is a terminal that operates as the MPS.

In step 670, when the message received in step 650 includes the registration required indicator, the UE 601 performs a registration procedure, and upon performing, the UE 601 sets an establishment cause as priority services to a message which is sent to the RAN 602, and sends the message.

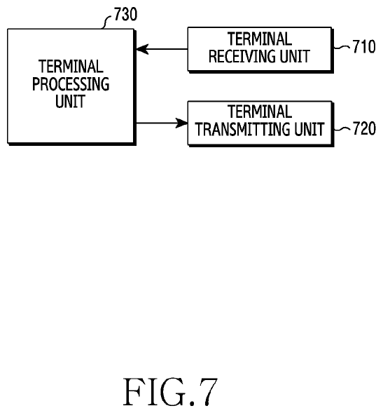

FIG. 7 illustrates a structure of a terminal according to an embodiment of the present disclosure.

Referring to FIG. 7, the terminal may include a terminal receiving unit 710, a terminal transmitting unit 720, and a terminal processing unit (e.g., control unit) 730.

The terminal receiving unit 710 and the terminal transmitting unit 720 may be collectively referred to as a transceiving unit. According to the communication method of the terminal described above, the terminal receiving unit 710, the terminal transmitting unit 720, and the terminal processing unit 730 of the terminal may operate. However, the components of the terminal are not limited to the above-described examples. For example, the terminal may include more components (e.g., a memory, etc.) or fewer components than the aforementioned components. In addition, the terminal receiving unit 710, the terminal transmitting unit 720, and the terminal processing unit 730 may be implemented in a single chip form as well.

The terminal receiving unit 710 and terminal transmitting unit 720 (or the transceiving unit) may transmit and receive signals to and from a base station. Here, the signal may include control information and data. To this end, the transceiving unit may include an RF transmitter for up-converting and amplifying a frequency of a transmitted signal, an RF receiver for low-noise amplifying a received signal and down-converting a frequency, and the like. However, this is only an embodiment of the transceiving unit, and the components of the transceiving unit are not limited to the RF transmitter and the RF receiver.

Also, the transceiving unit may receive a signal through a wireless channel and output the signal to the terminal processing unit 730, and transmit a signal outputted from the terminal processing unit 730 through the wireless channel.

A memory (not shown) may store programs and data required for operation of the terminal. Also, the memory may store control information or data included in a signal acquired from the terminal. The memory may include a storage medium such as a ROM, a RAM, a hard disk, a CD-ROM, a DVD, and the like, or a combination of storage media.

The terminal processing unit 730 may control a series of processes so that the terminal may operate according to the above-described embodiment of the present disclosure. The terminal processing unit 730 may be implemented as a circuit or an application-specific integrated circuit or at least one or more processors. The terminal processing unit 730 may be implemented as a control unit or one or more processors.

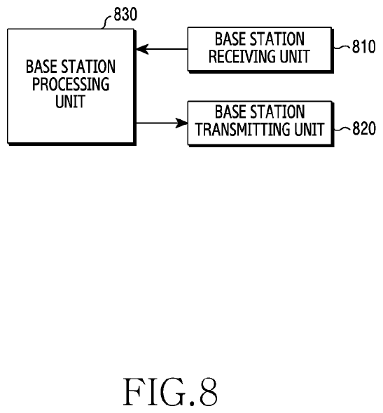

FIG. 8 illustrates a structure of a base station according to an embodiment of the present disclosure.

Referring to FIG. 8, the base station may include a base station receiving unit 810, a base station transmitting unit 820, and a base station processing unit (e.g., control unit) 830.

The base station receiving unit 810 and the base station transmitting unit 820 may be collectively referred to as a transceiving unit. According to the communication method of the base station described above, the base station receiving unit 810, the base station transmitting unit 820, and the base station processing unit 830 of the base station may operate. However, the components of the base station are not limited to the above-described examples. For example, the base station may include more components (e.g., a memory, etc.) or fewer components than the aforementioned components. In addition, the base station receiving unit 810, the base station transmitting unit 820, and the base station processing unit 830 may be implemented in a single chip form as well.

The base station receiving unit 810 and base station transmitting unit 820 (or the transceiving unit) may transmit and receive signals to and from a terminal and/or a network entity. Here, the signal may include control information and data. To this end, the transceiving unit may include an RF transmitter for up-converting and amplifying a frequency of a transmitted signal, an RF receiver for low-noise amplifying a received signal and down-converting a frequency, and the like. However, this is only an embodiment of the transceiving unit, and the components of the transceiving unit are not limited to the RF transmitter and the RF receiver.

Also, the transceiving unit may receive a signal through a wired/wireless channel and output the signal to the base station processing unit 830, and transmit a signal outputted from the base station processing unit 830 through the wired/wireless channel.

A memory (not shown) may store programs and data required for operation of the base station. Also, the memory may store control information or data included in a signal acquired from the base station. The memory may include a storage medium such as a ROM, a RAM, a hard disk, a CD-ROM, a DVD, and the like, or a combination of storage media.

The base station processing unit 830 may control a series of processes so that the base station operates according to the above-described embodiment of the present disclosure. The base station processing unit 830 may be implemented as a control unit or one or more processors.

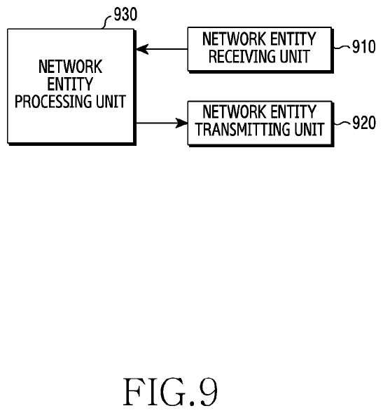

FIG. 9 illustrates a structure of a network entity according to an embodiment of the present disclosure.

Referring to FIG. 9, the network entity may include a network entity receiving unit 910, a network entity transmitting unit 920, and a network entity processing unit (e.g., control unit) 930. Here, the network entity may include AMF, SMF, UPF, DN, NSSF, NEF, AUSF, NRF, PCF, UDM, AF, and the like.

The network entity receiving unit 910 and the network entity transmitting unit 920 may be collectively referred to as a transceiving unit. According to the communication method of the network entity described above, the network entity receiving unit 910, the network entity transmitting unit 920, and the network entity processing unit 930 of the network entity may operate. However, the components of the network entity are not limited to the above examples. For example, the network entity may include more components (e.g., a memory, etc.) or fewer components than the aforementioned components. In addition, the network entity receiving unit 910, the network entity transmitting unit 920, and the network entity processing unit 930 may be implemented in a single chip form as well.

The network entity receiving unit 910 and network entity transmitting unit 920 (or the transceiving unit) may transmit and receive signals to and from a base station and/or other network entities. Here, the signal may include control information and data. The transceiving unit may receive a signal through a wired/wireless channel and output the signal to the network entity processing unit 930, and transmit a signal outputted from the network entity processing unit 930 through the wired/wireless channel.

A memory (not shown) may store programs and data required for operation of the network entity. Also, the memory may store control information or data included in a signal acquired from the network entity. The memory may include a storage medium such as a ROM, a RAM, a hard disk, a CD-ROM, and a DVD, or a combination of storage media.

The network entity processing unit 930 may control a series of processes so that the network entity may operate according to the above-described embodiment of the present disclosure. The network entity processing unit 930 may be implemented as a control unit or one or more processors.

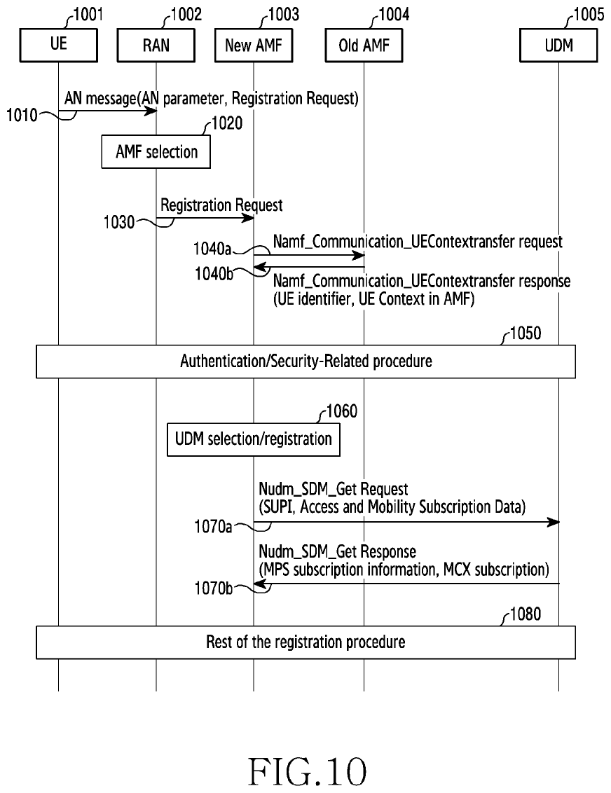

FIG. 10 illustrates a method of finding out whether a new AMF has subscribed to an MPS, an MCX, or an MPS/MCX in a network registration procedure of a terminal according to an embodiment of the present disclosure.

In step 1010, a UE 1001 may transmit an AN message including an AN parameter and a registration request to an RAN 1002. At this time, the registration request may include a UE identifier (e.g., a subscription concealed identifier (SUCI), a 5G-global unique temporary identity (5G-GUTI), a permanent equipment identifier (PEI), etc.), requested NSSAI, a UE mobility management (MM) core network capability, etc.

In step 1020, the RAN 1002 may select an AMF 1003, based on information in the AN message received from the UE 1001.

In step 1030, the RAN 1002 may deliver an N2 message including an N2 parameter and a registration request to the AMF 1003. The N2 parameter may include a selected PLMN ID, UE location information, a UE context request, and the like.

In step 1030, the AMF 1003 may check whether information indicating whether the UE 1001 has subscribed to a priority service is included in a UE context. Here, the information indicating whether the UE 1001 has subscribed to the priority service may include information indicating whether the UE 1001 has subscribed to the MPS and/or the MCX. Based on this information, the AMF 1003 may check whether the UE 1001 has subscribed to the MPS, the MCX, or both the MPS and the MCX in the UE context. When the UE 1001 has subscribed to the priority service, the AMF 1003 may preferentially process a control plane message for the UE 1001 (that is, preferentially process the corresponding message even in a congestion situation), and omit or exempt NSAC and NSSAA for slices requested by the UE 1001. When the AMF 1003 is a newly changed AMF, the AMF 1003 may perform steps 1040a and 1040b.

In step 1040a, the new AMF 1003 may determine an old AMF 1004, based on the 5G-GUTI received in step 1030, and request UE context transmission to the old AMF 1004.

In step 1040b, when the old AMF 1004 receives a UE context transmission request message from the new AMF 1003, the old AMF 1004 may transmit a UE context to the new AMF 1003. At this time, the UE context may include information indicating whether the UE 1001 has subscribed to a priority service in the UE context. Here, the information indicating whether the UE 1001 has subscribed to the priority service may include information indicating whether the UE 1001 has subscribed to the MPS and/or the MCX. When the UE 1001 has subscribed to the priority service, the new AMF 1003 may preferentially process the control plane message for the UE 1001 (that is, preferentially process the corresponding message even in a congestion situation), and omit or exempt NSAC and NSSAA for slices requested by the UE 1001.

In step 1050, when the AMF 1003 determines that UE authentication is required, the AMF 1003 may select an authentication server function (AUSF), based on the UE identifier (e.g., the SUCI or SUPI), and perform an authentication procedure for the UE 1001 through the selected AUSF. Also, when there is no security context for NAS communication for the UE 1001, a procedure for acquiring this may be performed.

In step 1060, the AMF 1003 may select a UDM 1005, based on the SUPI (i.e., the UE identifier). Also, the UDM 1005 may select a UDR in which subscription information for the UE 1001 is stored. The AMF 1003 may request the UDM 1005 to register an access type (e.g., 3GPP access or non-3GPP access) for which a registration request of the UE 1003 has been received.

In step 1070a, the AMF 1003 may transmit a Nudm_SDM_Get request message which includes an indicator requesting UE identifier information and access and mobility subscription data information, to the UDM 1005, and request access and mobility subscription information to the UDM 1005. When the information indicating whether the UE 1001 has subscribed to the MPS and/or MCX is included in the UE context, the AMF 1003 may not request the corresponding information to the UDM 1005. When the information indicating whether the UE 1001 has subscribed to the MPS and/or MCX is not included in the UE context, that is, when whether the UE 1001 has subscribed to the MPS and/or MCX cannot be known, the AMF 1003 may include an indicator requesting the corresponding information to the UDM 1005 in the Nudm_SDM_Get request message.

In step 1070b, the UDM 1005 transmits a Nudm_SDM_Get response message which includes access and mobility subscription data, to the AMF 1003. At this time, the UDM 1005 may acquire the access and mobility subscription data from the UDR. At this time, when the message received from the AMF 1003 in step 1070a includes an indicator requesting MPS subscription information and/or an indicator requesting MCX subscription information, or when the message includes information informing that the AMF 1003 is a modified AMF, the UDM 1005 may include the MPS subscription information and/or MCX subscription information in the Nudm_SDM_Get response message transmitted to the AMF 1003.

When the Nudm_SDM_Get response message from the UDM 1005 includes the MPS subscription information and/or MCX subscription information, the AMF 1003 may preferentially process the control plane message for the UE 1001 (that is, preferentially process the corresponding message even in a congestion situation), and omit or exempt NSAC and NSSAA for slices requested by the UE 1001. When the Nudm_SDM_Get response message from the UDM 1005 includes the MPS subscription information and/or MCX subscription information, the AMF 1003 may store the corresponding information (that is, whether the UE has subscribed to the MPS and/or the MCX) in the UE context within the AMF 1003.

In step 1080, the remaining terminal registration procedures are performed.

Methods of embodiments described in the claims or specification of the present disclosure may be implemented in the form of hardware, software, or a combination of hardware and software.

When implemented in software, a computer-readable storage medium storing one or more programs (software modules) may be presented. One or more programs stored in the computer-readable storage medium are configured for execution by one or more processors in an electronic device. The one or more programs include instructions that cause the electronic device to execute methods of embodiments described in the claims or specification of the present disclosure.

Such programs (software modules and software) may be stored in a random access memory, a non-volatile memory including a flash memory, a read only memory (ROM), an electrically erasable programmable ROM (EEPROM), a magnetic disc storage device, a compact disc-ROM (CD-ROM), digital versatile discs (DVDs) or other forms of optical storage devices, and a magnetic cassette. Or it may be stored in a memory composed of a combination of some or all thereof. Also, each configuration memory may be included in plurality as well.

Also, the program may be stored in an attachable storage device that may be accessed through a communication network such as the Internet, an intranet, a local area network (LAN), a wide area network (WAN), or a storage area network (SAN), or a communication network consisting of a combination thereof. This storage device may be coupled to a device performing an embodiment of the present disclosure through an external port. Also, a separate storage device on the communication network may be coupled to the device performing the embodiment of the present disclosure as well.

In embodiments of the present disclosure, components included in the present disclosure are expressed as singular or plural according to the embodiments presented. However, the singular or plural expression is appropriately selected for the context presented for convenience of description, and the present disclosure is not limited to the singular or plural component, and even if a component is expressed as plural, it may be composed of singular, or even if the component is expressed as singular, it may be composed of plural.

In the drawings describing the embodiments of the present disclosure, the order of explanation does not necessarily correspond to the order of execution, and the order of precedence may be changed or executed in parallel. Also, the drawings describing the embodiments of the present disclosure may omit some components and include only some components within a range that does not impair the essence of the present disclosure.

In embodiments of the present disclosure, some or all of the contents included in each embodiment may be combined and executed within the range that does not impair the essence of the present disclosure.

On the other hand, the embodiments of the present disclosure disclosed in the present specification and drawings are only presented as specific examples to easily explain the technical content of the present disclosure and help understanding of the present disclosure, and are not intended to limit the scope of the present disclosure. That is, it is obvious to those skilled in the art that other modified examples based on the technical idea of the present disclosure may be implemented.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of an access and mobility management function (AMF) entity in a wireless communication system, the method comprising:
receiving, from a unified data management (UDM) entity, an update notification message including first information for a multimedia priority service (MPS) priority;
transmitting, to a user equipment (UE), a configuration update command message including second information for the MPS priority based on the first information; and
receiving, from the UE, a registration request message based on the second information.

2. The method of claim 1, wherein the update notification message is received from the UDM entity without a transmission of a request message to the UDM entity.

3. The method of claim 1, wherein the UE determines whether an access identity 1 is valid based on the second information.

4. The method of claim 1, wherein the registration request message includes a parameter of establishment cause indicating a priority service.

5. The method of claim 4, further comprising:
transmitting, to the UE, a registration accept message without authentication in at least one of a network slice admission control (NSAC) procedure or a network slice-specific authentication and authorization (NSSAA) procedure.

6. A method of a user equipment (UE) in a wireless communication system, the method comprising:
receiving, from an access and mobility management function (AMF) entity, a configuration update command message including second information for a multimedia priority service (MPS) priority based on first information for an MPS; and
transmitting, to the UE, a registration request message based on the second information,
wherein the first information is included in an update notification message transmitted to the AMF entity from a unified data management (UDM) entity.

7. The method of claim 6, further comprising:
determining whether an access identity 1 is valid based on the second information.

8. The method of claim 6, wherein the registration request message includes a parameter of establishment cause indicating a priority service.

9. The method of claim 8, further comprising:
receiving, from the AMF entity, a registration accept message without authentication in at least one of a network slice admission control (NSAC) procedure or a network slice-specific authentication and authorization (NSSAA) procedure.

10. An access and mobility management function (AMF) entity in a wireless communication system, the AMF entity comprising:
a transceiver; and
a controller operably coupled to the transceiver, the controller configured to:
receive, from a unified data management (UDM) entity, an update notification message including first information on a multimedia priority service (MPS) priority,
transmit, to a user equipment (UE), a configuration update command message including second information for the MPS priority based on the first information, and
receive, from the UE, a registration request message based on the second information.

11. The AMF entity of claim 10, wherein the update notification message is received from the UDM entity without a transmission of a request message to the UDM entity.

12. The AMF entity of claim 10, wherein the UE determines whether an access identity 1 is valid based on the second information.

13. The AMF entity of claim 10, wherein the registration request message includes a parameter of establishment cause indicating a priority service.

14. The AMF entity of claim 10, wherein the controller is further configured to:
transmit, to the UE, a registration accept message without authentication in at least one of a network slice admission control (NSAC) procedure or a network slice-specific authentication and authorization (NSSAA) procedure.

15. A user equipment (UE) in a wireless communication system, the UE comprising:
a transceiver; and
a controller operably coupled to the transceiver, the controller configured to:
receive, from an access and mobility management function (AMF) entity, a configuration update command message including second information for a multimedia priority service (VIPS) priority based on first information for an MPS, and
transmit, to the UE, a registration request message based on the second information,
wherein the first information is included in an update notification message transmitted to the AMF entity from a unified data management (UDM) entity.

16. The UE of claim 15, wherein the controller is further configured to:
determine whether an access identity 1 is valid based on the second information.

17. The UE of claim 15, wherein the registration request message includes a parameter of establishment cause indicating a priority service.

18. The UE of claim 17, wherein the controller is further configured to:
receive, from the AMF entity, a registration accept message without authentication in at least one of a network slice admission control (NSAC) procedure or a network slice-specific authentication and authorization (NSSAA) procedure.
